(19) United States
(12) Patent Application Publication
(10) Pub. No.: US 2017/0192342 A1
(43) Pub. Date: Jul. 6, 2017

(54) CAMERA APPARATUS

(71) Applicant: ZEROTECH (Chongqing) Intelligence Technology Co., Ltd., Chongqing (CN)

(72) Inventors: Geng-Peng Liu, Beijing (CN); Hong-Tao Sun, Beijing (CN)

(73) Assignee: ZEROTECH (Chongqing) Intelligence Technology Co., Ltd., Chongqing (CN)

(21) Appl. No.: 15/395,509

(22) Filed: Dec. 30, 2016

(30) Foreign Application Priority Data
Jan. 5, 2016 (CN) 201620010223.0
May 17, 2016 (CN) 201620449932.9

(51) Int. Cl. G03B 17/56; G03B 5/00; H04N 5/225

(52) U.S. Cl. CPC G03B 17/561; H04N 5/2252; H04N 5/2253; G03B 5/00; G03B 2205/0092; G03B 2205/0069

(57) ABSTRACT

A camera apparatus is disclosed. The camera apparatus comprises a first motor, a camera housing and a camera module. The camera housing is fixed directly to the motor. The camera module is located in the camera housing and capable of rotating along with the motor via the camera housing.

### CROSS-REFERENCE TO RELATED APPLICATIONS

This application claims all benefits accruing under 35 U.S.C. §119 from China Patent Application No. 201620010223.0, filed on Jan. 5, 2016 and No. 201620449932.9, filed on May 17, 2016 in the State Intellectual Property Office of China, the contents of all of which are hereby incorporated by reference.

### FIELD

The present disclosure relates to cameras, and more particularly to a camera apparatus with a pan/tilt unit.

### BACKGROUND

Cameras are commonly carried through platforms, such as gimbals, that are mounted on mobile devices such as aerial vehicles and handheld devices. The camera is usually an independent device, and is detachably connected with the gimbal. The camera moves stably with a motor rotation of the gimbal and a perspective of the camera can be regulated. With a miniaturized development of the mobile devices, the gimbal also develops in the direction of miniaturization. However, as a separate device, the camera must be connected with the motor of the gimbal through additional connecting members, which increases a total mass, a moment of inertia, and occupation of space, which is counter to the miniaturization of the mobile devices.

### BRIEF DESCRIPTION OF THE DRAWINGS

Implementations are described by way of example only with reference to the attached figures.

FIG. 1 is a schematic view of a first embodiment of a camera apparatus.

FIG. 2 is an exploded view from a side of the first embodiment of the camera apparatus.

FIG. 3 is an exploded view from another side of the first embodiment of the camera apparatus.

FIG. 4 is a schematic view of a second embodiment of the camera apparatus.

FIG. 5 is an exploded view of the second embodiment of the camera apparatus.

FIG. 6 is a schematic view of a third embodiment of the camera apparatus.

FIG. 7 is an exploded view of the third embodiment of the camera apparatus.

FIG. 8 is another exploded view of the third embodiment of the camera apparatus.

FIG. 9 is a front view of the third embodiment of the camera apparatus.

FIG. 10 is a back view of the third embodiment of the camera apparatus.

FIG. 11 is a side view of the third embodiment of the camera apparatus.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

In the present disclosure, the terms “vertical” “horizontal” and other similar direction-indicating terms are used with reference to the camera in its normal operational mode, and should not be considered limiting.

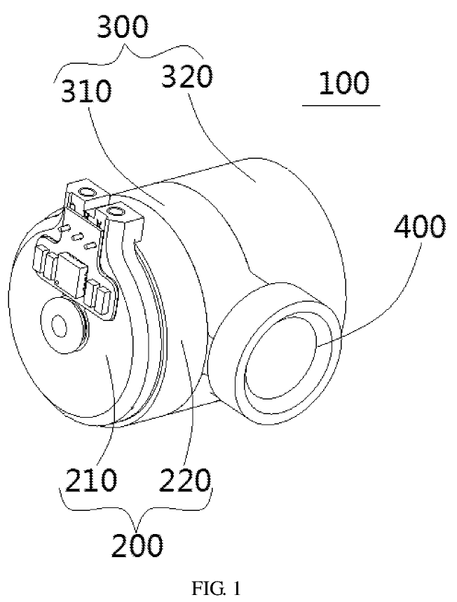

Referring to FIG. 1, a camera apparatus 100 according to a first embodiment is shown. The camera apparatus 100 includes a motor 200, a camera housing 300, and a camera module 400. The camera housing 300 is a connecting member between the motor 200 and the camera module 400.

The motor 200 can include a stator 210 and a rotor casing 220. The rotor casing 220 can be rotatably connected to the stator 210, and rotate relatively to the stator 210.

The camera module 400 can include a camera lens and a camera body having the camera lens mounted thereon. The camera body includes a back surface faced to the back of the camera lens.

The camera module 400 is located in the camera housing 300, and the camera housing 300 is fixed directly to the motor 200. The camera module 400 is capable of rotating along with the motor 200 via the camera housing 300. The camera lens can be exposed from the camera housing 300.

It is noted that the camera housing 300 is both an installation structure of the camera module 400, and the connecting member connecting the camera module 400 with the motor 200. Thus, without additional means, the volume, weight, and cost of the camera apparatus 100 can be reduced, which is beneficial to the miniaturization and integration of the camera apparatus 100.

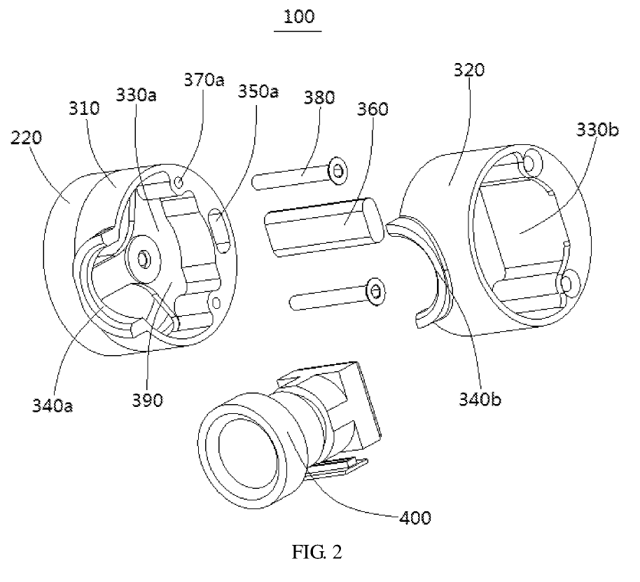

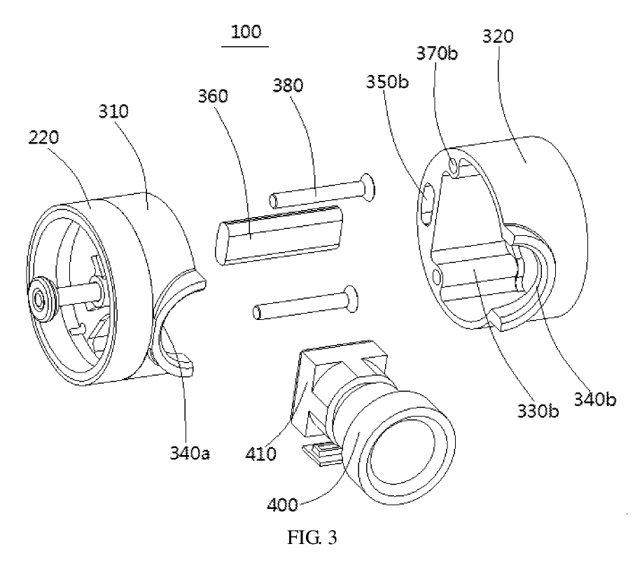

Referring to FIG. 2 and FIG. 3, in one embodiment, a first end of the camera housing 300 is fixed directly to the rotor casing 200. In some embodiments, the first end of the camera housing 300 is embedded into the rotor casing 220 by an interference fit. In some other embodiments, the first end of the camera housing 300 is integrally formed with the rotor casing 220 together as one piece. It should be understood that the first end of the camera housing 300 can be fixed directly to the rotor casing 200 by other means.

The camera housing 300 can include a first housing 310 and a second housing 320. The first housing 310 comprising the first end can be fixed directly to the rotor casing 220. In some embodiments, the first housing 310 is an insertion inserted into the rotor casing 220, and the insertion can be made of a material with a low density such as aluminum. In some embodiments, the first housing 310 can be a part of the rotor casing 220. In other embodiments, the first housing 310 and the rotor casing 220 can be integrated with each other as a single unitary piece. The second housing 320 and the first housing 310 can cooperatively fix the camera module 400 in the camera housing 300. The camera module 400 can be tightly pressed by the first housing 310 and the second housing 320, so that the camera module 400 is fixed firmly therebetween.

In one embodiment, the first housing 310 defines a first cavity 330a. The second housing 320 defines a second cavity 330b. The first housing 310 is connected to the second housing 320, and the first cavity 330a and the second cavity 330b are combined to form a holding cavity to receive the camera module 400.

It is noted that the camera module 400 is received in the holding cavity when the first housing 310 is connected to the second housing 320. A part of the camera module 400 is received in the first cavity 330a, and another part of the camera module 400 is received in the second cavity 330b.

The first housing 310 and the second housing 320 can both be tubular shaped. A first arc shaped opening 340a can be defined on a first side wall of the first housing 310. A second arc shaped opening 340b can be defined on a second side wall of the second housing 320. The first arc shaped opening 340a and the second arc shaped opening 340b together form a limiting hole through which the camera lens is capable of extending out.

The first arc shaped opening 340a opens into the first cavity 330a, and the second arc shaped opening 340b opens into the second cavity 330b. The camera lens extends out through the limiting hole formed by the first arc shaped opening 340a and the second arc shaped opening 340b. The camera body is received in the holding cavity formed by the first cavity 330a and the second cavity 330b.

In one embodiment, the first arc shaped opening 340 and the second arc shaped opening 340b cooperatively define the limiting hole with a shape that closely matches a shape of the camera lens extending therethough. The first arc shaped opening 340 and the second arc shaped opening 340b can both be semicircular to form a perfect circle when combined. The camera lens can be tightly fitted in the limiting hole to prevent the camera lens from swinging, shaking and rotating, to firmly fix the camera module 400.

An anti-rotating surface 390 can be located on a first inner wall of the first housing 310 or a second inner wall of the second housing 320. A contacting surface 410 can be located on the camera module 400 corresponding to the anti-rotating surface 390. The contacting surface 410 can be abutted on the anti-rotating surface 390 to prevent the camera module 400 from rotating about an axis of the camera lens, to firmly fix the camera module 400. The contacting surface 410 and the anti-rotating surface 390 can be flat surfaces.

As the camera lens extends out through the limiting hole, the weight of the camera module 400 could be unbalanced, and the center of gravity of the camera module 400 could be shifted during movement so that the shooting effect could be affected. To solve the above technical problems, a third counterweight structure 360 can be located on the camera housing 300 to regulate the center of gravity of the camera module 400. Due to the third counterweight structure 360, the center of gravity of the camera module 400 can be shifted slightly or significantly during movement to ensure the shooting effect.

The third counterweight structure 360 can be a counterweight block such as a copper block. More specifically, a first containing hole 350a is defined on the first side wall of the first housing 310 opposite to the first arc shaped opening 340a. The first containing hole 350a extends along an axis in a direction from the first housing 310 to the second housing 320. A second containing hole 350b is defined on a second side wall of the second housing 320 corresponding to the first containing hole 350a and extending along the same axis as the first containing hole 350a. The first containing hole 350a and the second containing hole 350b cooperatively form a counterweight hole to receive the counterweight block.

The first containing hole 350a can be formed on a thickened portion of the first side wall of the first housing 310. Correspondingly, the second containing hole 350b can be formed on a thickened portion of the second side wall of the second housing 320. The thickened portions of the first side wall and the second side wall can cooperatively form a matching surface to contact the back surface of the camera body, to firmly fix the camera module 400.

It is noted that the center of gravity of the camera module 400 can be regulated without the third counterweight structure 360. In some embodiments, the center of gravity of the camera module 400 can be regulated by adjusting a structure of the camera housing 300 according to the location of the camera module 400, such as by adjusting the structures of the first housing 310 and the second housing 320.

Furthermore, a first connecting hole 370a can be defined on the first housing 310. A second connecting hole 370b can be defined on the second housing 320. A connecting hole is a combination of the first connecting hole 370a and the second connecting hole 370b. A connecting element 380 can be received in the connecting hole to firmly connect the first housing 310 and the second housing 320. In one embodiment, two first connecting holes 370a are defined on opposite sides of the first containing hole 350a, and two second connecting holes 370b are defined on opposite sides of the second containing hole 350b.

From the above, in the camera apparatus 100, the installation structure of the camera module 400 and the connecting member between the camera module 400 and the motor 200 are integrated as the camera housing 300, which reduces both the volume, weight and cost of the camera apparatus 100 and is beneficial to the miniaturization and integration of camera apparatus 100.

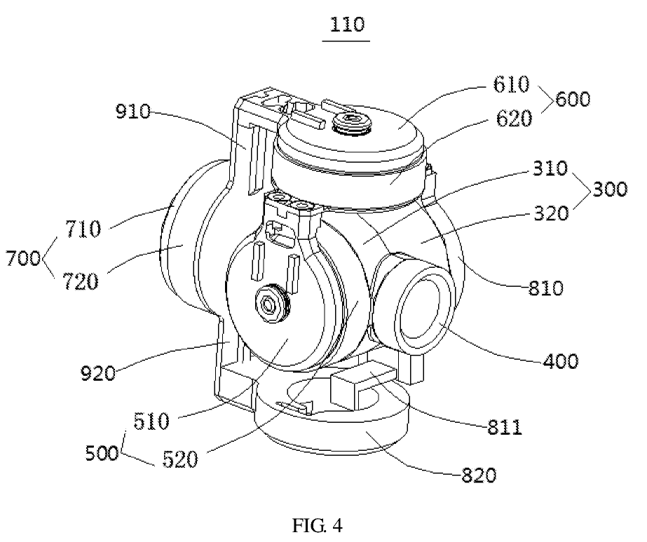

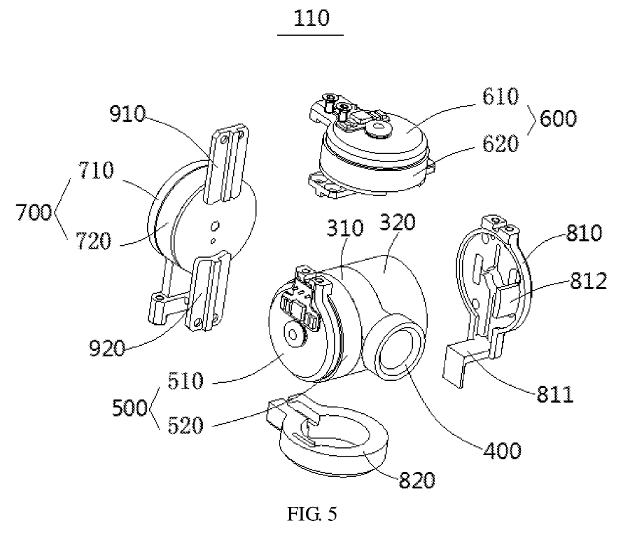

Referring to FIG. 4 and FIG. 5, a camera apparatus 110 according to a second embodiment is shown. The camera apparatus 110 includes the camera housing 300, the camera module 400, a first motor 500, a second motor 600, and a third motor 700. A first rotation axis of the first motor 500, a second rotation axis of the second motor 600, and a third rotation axis of the third motor 700 can be orthogonal to each other.

The first motor 500 can include a first stator 510 and a first rotor casing 520, which is capable of rotating relatively to the first stator 510. The second motor 600 can include a second stator 610 and a second rotor casing 620, which is capable of rotating relatively to the second stator 610. The third motor 700 can include a third stator 710 and a third rotor casing 720, which is capable of rotating relatively to the third stator 710.

Any one of the first motor 500, the second motor 600 and the third motor 700 can be connected to the camera housing 300 by the same way with the motor 200. One of the first, second, and third motors 500, 600, 700 can be a pan motor rotating the camera module 400 horizontally from a fixed position, and the other two of the first, second, and third motors 500, 600, 700 can be tilt motors rotating the camera module 400 vertically from the fixed position.

In the exemplary embodiment, the first motor 500 can be connected to the camera housing 300 in the same manner as the motor 200. The first motor 500 and the third motor 700 are the tilt motors, and the second motor 600 is the pan motor.

The second rotor casing 620 can be connected to the first stator 510. The first motor 500 and the camera module 400 are capable of rotating along the second rotor casing 620. More specifically, one end of the second rotor casing 620 can be connected to one side of the first stator 510.

The third rotor casing 720 can be connected to the second stator 610. The second motor 600, the first motor 500 and the camera module 400 are capable of rotating along with the third rotor casing 720. The third rotor casing 720 can be connected to the second stator 610 via a first arm 910.

The camera apparatus 110 can further include a first counterweight structure 810 and a second counterweight structure 820 to regulate the center of gravity of the camera module 400. The first counterweight structure 810 and the first motor 500 can be respectively located on first opposite sides of the camera housing 300. The second counterweight structure 820 and the second motor 600 can be respectively located on second opposite sides of the camera housing 300. The third motor 700 and the camera lens can be located on third opposite sides of the camera housing 300. The first, second, and third opposite sides can be substantially perpendicular to each other.

The second counterweight structure 820 can be connected to the third rotor casing 720 via a second arm 920. Preferably, the first arm 910 and the second arm 920 are aligned in the same line. The second counterweight structure 820 can be disc-shaped, wherein a containing chamber is defined.

The first counterweight structure 810 can be connected to the second rotor casing 620. The first counterweight structure 810 can be covered at one end of the second housing 320 far away from the first housing 310. A fixture block 812 can be connected to one side of the first counterweight structure 810. The fixture block 812 can be received in the second holding cavity 330b of the second housing 320.

One end of the first counterweight structure 810 is connected to one side of the second rotor casing 620, and the other end is connected to a rotating arm 811. One end of the rotating arm 811 extends into the containing chamber of the second counterweight structure 820. The rotating arm 811 is capable of rotating in the containing chamber around the second rotation axis. The first counterweight structure 810 can be disc-shaped. The rotating arm 811 can be L-shaped.

When the first motor 500 is operating, the first rotor casing 520 rotates relatively to the first stator 510, the first housing 310 rotates along with the first rotor casing 520, and finally the second housing 320 and the camera module 400 rotate along with the first housing 320 relatively to the first counterweight structure 810.

When the third motor 700 is operating, the third rotor casing 720 rotates relatively to the third stator 710, the first link arm 910 and the second link arm 920 rotate along with the third rotor casing 720 in the same direction (clockwise or counter-clockwise), the second motor 600 and the second counterweight structure 820 rotate along with the first link arm 910 and the second link arm 920, the first motor 500 rotates along with the second motor 600, and finally the camera module 400 rotates along with the first motor 500.

When the second motor 600 is operating, the second rotor casing 620 rotates relatively to the second stator 610, the motor 500 and the first counterweight structure 810 rotate along with the second rotor casing 620, the camera module 400 rotates along with the motor 500, and the rotating arm 811 rotates in the containing chamber of the second counterweight structure 820.

The first counterweight structure 810 and the second counterweight structure 820 are not only used as counterweights of the camera apparatus 100, but also used for wiring of flexible printed circuit (“FPC”) wires. That is, the FPC wires of the first motor 500, the second motor 600, and the third motor 700 are connected to a controller via the first counterweight structure 810 and the second counterweight structure 820. A first wiring hole can be defined on the first counterweight structure 810. A second wiring hole can be defined on the first counterweight structure 820. The FPC wires can be wired through the first wiring hole and the second wiring hole.

It is noted that the center of gravity of the camera module 400 can be regulated without the first counterweight structure 810 and the second counterweight structure 820. In some embodiments, the center of gravity of the camera module 400 can be regulated by adjusting the distance of the camera housing 400 and the first motor 500 to the second motor 600, and/or the distance of the camera housing 400 and the first motor 500 to the third motor 700. In some embodiments, the center of gravity of the camera module 400 can be regulated by adjusting the lengths of the motor shafts of the three motors.

In the camera apparatus 110, the camera housing 300, the camera module 400, the first motor 500, the second motor 600, the third motor 700, the first counterweights structure 810, and the second counterweights structure 820 are designed in combination, which significantly reduces the weight and the space occupation of the camera apparatus 110 and is beneficial to the miniaturization and integration of camera apparatus 110.

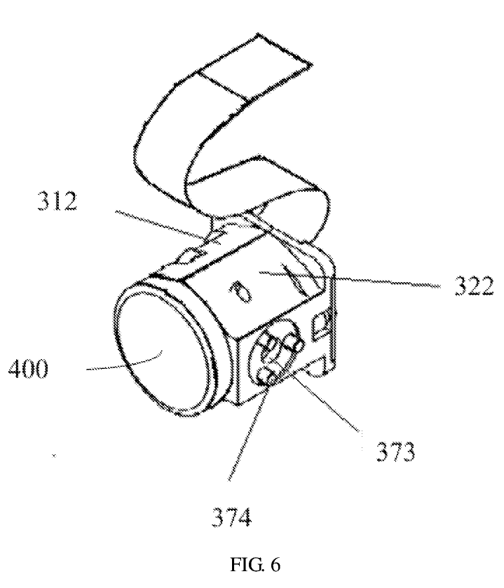

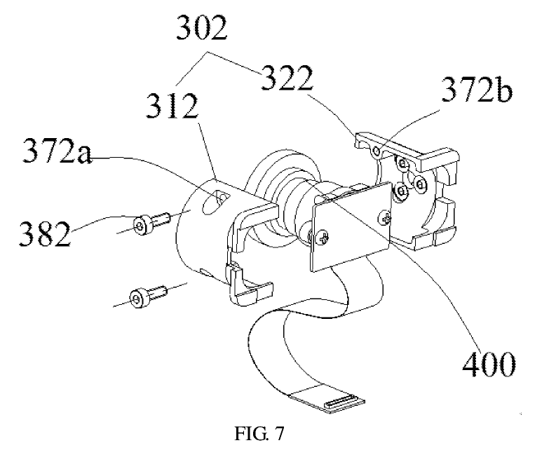

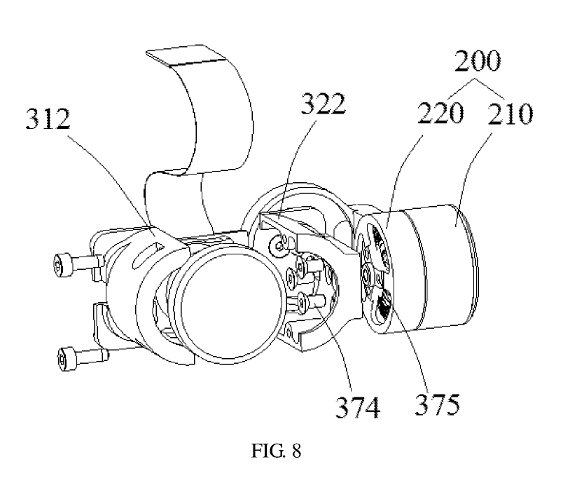

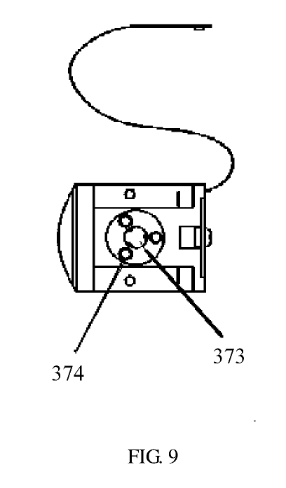

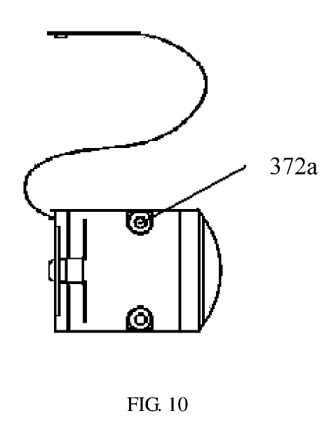

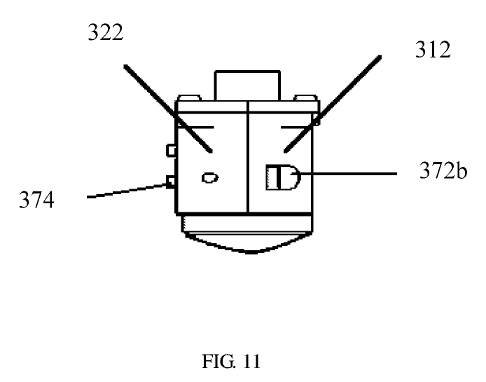

Referring to FIG. 6 through FIG. 11, one embodiment of a camera housing 302 configured to enclose the camera module 400 is shown. The camera module 400 comprises a camera lens, a camera body, and a rear portion opposite to the camera lens.

The camera body is located in the camera housing 302 and comprises an outer peripheral surface between the camera lens and the rear portion. The camera housing 302 can have a sleeve shape, and is sleeved outside the outer peripheral surface of the camera body. The camera housing 302 can include a first housing 312 and a second housing 322 detachable connected with each other. The camera module 400 can be fitted tightly by the first housing 310 and the second housing 320, to firmly fix the camera module 400.

A combination of a first inner wall of the first housing 312 and a second inner wall of the second housing 322 can be matched with the outer peripheral surface of the camera body. In one embodiment, the first inner wall of the first housing 311 and the second inner wall of the second housing 321 are both columnar with a semicircular cross section, and a hollow column can be formed by their combination. The camera body is located in the hollow column, the camera lens is exposed out from the camera housing 312 to take photographs or shoot videos, and the rear portion is exposed out from the camera housing 312 to be used and observed conveniently. It is noted that the rear portion can be located in the camera housing 302 in other embodiments.

In one embodiment, a first connecting hole 372a can be defined on the first housing 312. A second connecting hole 372b can be defined on the second housing 322. A connecting hole can be formed by combination of the first connecting hole 372a and the second connecting hole 372b. A connecting element 382 can be received in the connecting hole to firmly connect the first housing 312 and the second housing 322. In one embodiment, two first connecting holes 372a are defined on opposite sides of the first containing hole 350a, and two second connecting holes 372b are defined on opposite sides of the second containing hole 350b. The first connecting hole 372a can be a through-hole, the second connecting hole 372b can be a screw hole or a threaded hole, and the connecting element 382 can be a screw, fastener, or other connecting element. It is noted that the first housing 312 and the second housing 322 can be connected by other means such as snap fit in other embodiments.

The camera housing 302 can be fixed directly to the motor 200. The camera module 400 is capable of rotating along with the motor 200 via the camera housing 302.

One side of the camera housing 302 can be fixed directly to the motor 200. A third connecting hole 373 can be defined on the one side of the second housing 322. The second housing 322 can be fixed directly to the motor 200 through the third connecting hole 373.

In one embodiment, a rotor can be embedded into the third connecting hole 373 by an interference fit. In one embodiment, the rotor casing 220 can be embedded into the third connecting hole 373 by an interference fit. In one embodiment, the rotor casing 220 can be integrally formed with the rotor casing 220 as one piece.

In one embodiment, the second housing 322 further includes a plurality of fixing columns 374 around the third connecting hole 373, and a plurality of fixing holes 375 are defined on the rotor casing 220 corresponding to the plurality of fixing columns 374. The plurality of fixing columns 374 can be inserted into the fixing holes 375 on the rotor casing 220, to fix the second housing 322 directly to the motor 200. The plurality of fixing columns 374 can be uniformly arranged with a circular distribution around a center of the third connecting hole 373. It is noted that the second housing 322 can be connected to the motor 200 by other means, such as by a snap-fit engagement.

The camera housing 302 has lower volume, weight and cost, and can be mounted and dismounted easily. The camera module 400 can be fixed firmly in the camera housing 302. The camera housing 302 can be fixed directly to the motor 200, thus the weight and the space occupation of the camera apparatus 110 is reduced significantly, which is beneficial to the miniaturization and integration of camera apparatus 120.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A camera apparatus comprising:
a first motor;
a camera housing fixed directly to the first motor;
a camera module located in the camera housing and rotatable along with the first motor via the camera housing.

2. The camera apparatus of claim 1, wherein the first motor comprises a first stator and a first rotor casing, the first rotor casing is rotatably connected to the first stator, and a first end of the camera housing is fixed directly to the first rotor casing.

3. The camera apparatus of claim 2, wherein the first end of the camera housing is embedded into the first rotor casing by an interference fit.

4. The camera apparatus of claim 2, wherein the first end of the camera housing is integrally formed with the first rotor casing as one piece.

5. The camera apparatus of claim 2, wherein the camera housing comprises a first housing and a second housing; the first housing defines a first cavity, the second housing defines a second cavity, the first cavity and the second cavity are combined to form a holding cavity to receive the camera module; and the first housing is fixed directly to the first rotor casing.

6. The camera apparatus of claim 1, wherein an anti-rotating surface is located on an inner wall of the camera housing, a contacting surface is located on the camera module corresponding to the anti-rotating surface, and the contacting surface is capable of abutting on the anti-rotating surface to prevent the camera module from rotating.

7. The camera apparatus of claim 5, wherein the camera module comprises a camera lens, a first arc shaped opening is defined on a first side wall of the first housing, a second arc shaped opening is defined on a second side wall of the second housing, and the first arc shaped opening and the second arc shaped opening cooperatively form a limiting hole through which the camera lens is extendable.

8. The camera apparatus of claim 7, wherein a third counterweight structure is located on the camera housing to regulate a center of gravity of the camera module.

9. The camera apparatus of claim 8, wherein a first containing hole is defined on a first side wall of the first housing opposite to the first arc shaped opening, a second containing hole is defined on the second side wall of the second housing corresponding to the first containing hole, and the first containing hole and the second containing hole cooperatively form a counterweight hole to receive the counterweight structure.

10. The camera apparatus of claim 2, further comprising a second motor, a first rotation axis of the first motor is orthogonal to a second rotation axis of the second motor, the second motor comprises a second stator and a second rotor casing rotatably connected to the second stator, and the second rotor casing is connected to the first stator.

11. The camera apparatus of claim 10, further comprising a third motor, a third rotation axis of the third motor is respectively orthogonal to the first rotation axis and the second rotation axis, the third motor comprising a third stator and a third rotor casing rotatably connected to the third stator, and the third rotor casing is connected to the second stator.

12. The camera apparatus of claim 11, further comprising a first counterweight structure and a second counterweight structure, the first counterweight structure and the first motor is located on a first opposite sides of the camera housing, and the second counterweight structure and the second motor is located on a second opposite sides of the camera housing.

13. The camera apparatus of claim 12, wherein the third rotor casing is connected to the second counterweight structure.

14. The camera apparatus of claim 13, wherein the first counterweight structure is connected to the second rotor casing.

15. The camera apparatus of claim 14, wherein a rotating arm is located on one end of the first counterweight structure opposite to the second rotor casing, a containing chamber is defined in the second counterweight structure, and the rotating arm extends and is capable of rotating in the containing chamber.

16. The camera apparatus of claim 12, wherein the camera module comprises flexible printed circuit wires, the first counterweight structure and the second counterweight structure are configured to roll the flexible printed circuit wires.

17. The camera apparatus of claim 1, wherein the camera module comprises a camera body fixed in the camera housing, and the camera housing comprising a sleeve shape and is sleeved outside an outer peripheral surface of the camera body.

18. The camera apparatus of claim 17, wherein the camera housing comprises a first housing detachable connected to a second housing, a first inner wall of the first housing and a second inner wall of the second housing corresponds to the outer peripheral face of the camera body.

19. The camera apparatus of claim 1, wherein a connecting hole is defined on a side wall of the camera housing, and the camera housing is fixed directly to the motor via the connecting hole.

20. The camera apparatus of claim 19, wherein a plurality of fixing columns surround the connecting hole, a plurality of fixing holes are defined on the motor corresponding to the plurality of fixing columns, and the plurality of fixing columns are inserted into the plurality of fixing holes.
